(19) United States
(12) Patent Application Publication
(10) Pub. No.: US 2026/0276147 A1
(43) Pub. Date: Sep. 17, 2026

(54) ELECTRIC FIELD-ENHANCED UNDERGROUND HYDROGEN STORAGE SYSTEM AND METHOD

(71) Applicant: China University of Petroleum (East China), Qingdao (CN)

(72) Inventors: Yongfei YANG, Qingdao (CN); Zhenxiao SHANG, Qingdao (CN); Haoyun LI, Qingdao (CN); Haoran DONG, Qingdao (CN); Lei ZHANG, Qingdao (CN); Junjie ZHONG, Qingdao (CN); Hai SUN, Qingdao (CN); Kai ZHANG, Qingdao (CN); Jun YAO, Qingdao (CN)

(73) Assignee: China University of Petroleum (East China), Qingdao (CN)

(21) Appl. No.: 19/450,171

(22) Filed: Jan. 15, 2026

(30) Foreign Application Priority Data
Jan. 16, 2025 (CN) 202510067571.5

(51) Int. Cl. F17C 1/00

(52) U.S. Cl. CPC F17C 1/007; F17C 2221/012; F17C 2260/036; F17C 2270/0149

(57) ABSTRACT

An electric field-enhanced underground hydrogen storage system and method are provided. The system includes an injection-withdrawal well, a first electrode column module, and a second electrode column module. The injection-withdrawal well is used for injection and withdrawal of hydrogen, the first electrode column module represents an electrode of an electric field, and the second electrode column module represents another opposite electrode of the electric field. The first electrode column module and the second electrode column module can respectively carry charges of equal magnitude but opposite sign, and are located at both sides at the same distance from the injection-withdrawal well to form a non-uniform electric field in a reservoir.

### CROSS-REFERENCE TO RELATED APPLICATION

This patent application claims the benefit and priority of Chinese Patent Application No. 202510067571.5 filed with the China National Intellectual Property Administration on Jan. 16, 2025, the disclosure of which is incorporated by reference herein in its entirety as part of the present application.

### TECHNICAL FIELD

The present disclosure belongs to the technical field of underground hydrogen storage engineering, and in particular to an electric field-enhanced underground hydrogen storage system and method.

### BACKGROUND

Conventional hydrogen storage methods mainly include a high-pressure gas storage tank, low-temperature liquid hydrogen storage, and chemical storage (such as, metal hydrides). Although these methods have achieved short-term storage of hydrogen to a certain extent, there are obvious limitations. The high-pressure gas storage tank requires complex equipment to maintain a high-pressure state and has limited storage capacity. The low-temperature liquid hydrogen storage demands an extremely-low temperature, resulting in high energy consumption and complex technology. Although the chemical storage offers good stability, the efficiency of hydrogen desorption and re-adsorption processes is relatively low. Therefore, the conventional hydrogen storage methods are difficult to meet the demand for large-scale and long-term hydrogen storage under the future carbon neutrality target.

Underground hydrogen storage, as a novel hydrogen storage technology, is gradually gaining attention. The core idea of this technology is to use underground geological structures (such as salt caverns, depleted oil and gas reservoirs, and aquifers) as storage media, to inject hydrogen into the underground for long-term storage, and to flexibly extract the hydrogen during peak energy demand periods or special periods. Underground hydrogen storage has numerous significant advantages. Firstly, the storage capacity of the underground hydrogen storage is far superior to that of conventional methods and can meet the demand for industrial-scale hydrogen storage. Secondly, an underground storage environment features natural isolation and stability, which can effectively reduce the risk of hydrogen leakage. In addition, the integration of underground hydrogen storage with existing oil and gas storage and transportation infrastructure further reduces the technical transformation cost and the application threshold. Therefore, the underground hydrogen storage technology has demonstrated wide application prospects in the future energy structure transformation.

Although underground hydrogen storage has numerous advantages, it also faces a series of technical challenges. How to improve the injection-withdrawal efficiency and storage efficiency of the hydrogen is one of key problems. In the underground hydrogen storage engineering, the conventional injection method involves pressurizing hydrogen using surface equipment and injecting the hydrogen into a formation through a wellbore. The conventional withdrawal method is to reduce pressure and recover through the wellbore by using a reservoir pressure. In this conventional hydrogen injection-withdrawal method, the flow velocity of hydrogen is relatively low, and hydrogen can only be stored at the density corresponding to the temperature and pressure conditions of the formation, leading to a small hydrogen storage capacity.

### SUMMARY

An objective of the present disclosure is to provide an electric field-enhanced underground hydrogen storage system, which effectively solves the problems of low injection-withdrawal efficiency and small hydrogen storage capacity existing in a conventional injection-withdrawal mode in the current underground hydrogen storage engineering.

To solve the foregoing problem, the present disclosure employs the technical solutions as follows.

An electric field-enhanced underground hydrogen storage system includes an injection-withdrawal well, a first electrode column module, and a second electrode column module; where the injection-withdrawal well is used for injection and withdrawal of hydrogen, the first electrode column module represents an electrode of an electric field, and the second electrode column module represents another opposite electrode of the electric field; and the first electrode column module and the second electrode column module respectively carry charges of equal magnitude but opposite sign, and are located at both sides at a same distance from the injection-withdrawal well, thereby forming a non-uniform electric field in a reservoir.

Further, the injection-withdrawal well extends from a surface well-site into the interior of the reservoir and is located at a central position in the electric field-enhanced underground hydrogen storage system as a whole.

The first electrode column module is located at a side of the injection-withdrawal well, and has a height equal to a reservoir thickness of an underground hydrogen storage structure.

The second electrode column module is located at another side of the injection-withdrawal well opposite to the first electrode column module, and has a height equal to the reservoir thickness of the underground hydrogen storage structure.

Another objective of the present disclosure is to provide an electric field-enhanced underground hydrogen storage method, which is carried out using the electric field-enhanced underground hydrogen storage system of the foregoing embodiment, comprising: injecting the hydrogen into the reservoir of the underground hydrogen storage structure through the injection-withdrawal well, where during injection, the hydrogen is polarized in the non-uniform electric field formed by the first electrode column module and the second electrode column module, and an induced dipole is generated as the centers of positive and negative charges of the hydrogen no longer coincide; induced charges of equal magnitude but opposite sign are formed in a hydrogen molecule; and the two types of induced charges are subjected to electrostatic attraction and electrostatic repulsion of different magnitudes and opposite directions from the non-uniform electric field, thereby enabling the hydrogen to have a directional acceleration moving toward either the first electrode column module or the second electrode column module.

The hydrogen is withdrawn to the surface through the injection-withdrawal well, where during withdrawal, positive and negative poles of the non-uniform electric field are reversed according to a predetermined frequency, enabling the hydrogen to have a directional acceleration moving toward the injection-withdrawal well.

Further, reversing the positive and negative poles of the non-uniform electric field refers to reversing charge polarities of the first electrode column module and the second electrode column module.

Further, during hydrogen injection, the hydrogen respectively enters a reservoir half-region controlled by the first electrode column module and a reservoir half-region controlled by the second electrode column module through the injection-withdrawal well, and in this case, the first electrode column module is positively charged and the second electrode column module is negatively charged.

The hydrogen is polarized in the non-uniform electric field formed by the first electrode column module and the second electrode column module, and the induced dipole is generated as the centers of the positive and negative charges of the hydrogen no longer coincide; and the induced charges of equal magnitude but opposite sign are formed in the hydrogen molecule, where a positive charge is generated along a direction of an electric field line, and a negative charge is generated along an opposite direction of the electric field line.

In the reservoir half-region controlled by the first electrode column module, an electric field density at a position where the negative charge of the hydrogen molecule is located is greater, and an electric field density at a position where the positive charge is located is lower, such that the electrostatic attraction on the negative charge of the hydrogen molecule is greater than the electrostatic repulsion on the positive charge, a resultant force on the hydrogen molecule is non-zero and directed toward the first electrode column module, thereby enabling the hydrogen to generate an acceleration toward the first electrode column module and increasing a flow velocity of the hydrogen.

In the reservoir half-region controlled by the second electrode column module, an electric field density at a position where the positive charge of the hydrogen molecule is located is greater, and an electric field density at a position where the negative charge is located is lower, such that the electrostatic attraction on the positive charge of the hydrogen molecule is greater than the electrostatic repulsion on the negative charge, a resultant force on the hydrogen molecule is non-zero and directed toward the second electrode column module, thereby enabling the hydrogen to generate an acceleration toward the second electrode column module and increasing the flow velocity of the hydrogen.

During the hydrogen injection, the hydrogen in the reservoir half-region controlled by the first electrode column module is accelerated to flow toward the first electrode column module, and the hydrogen in the reservoir half-region controlled by the second electrode column module is accelerated to flow toward the second electrode column module.

Further, during hydrogen withdrawal, the hydrogen enters the injection-withdrawal well from the reservoir half-region controlled by the first electrode column module and the reservoir half-region controlled by the second electrode column module and is recovered to the surface well-site.

The positive and negative poles of the non-uniform electric field are reversed, such that the first electrode column module is negatively charged and the second electrode column module is positively charged, and in this case, the hydrogen is still in a polarized state established before electric field reversal.

In the reservoir half-region controlled by the first electrode column module, the electric field density at the position where the negative charge of the hydrogen molecule is located is greater, and the electric field density at the position where the positive charge is located is lower, such that the electrostatic repulsion on the negative charge of the hydrogen molecule is greater than the electrostatic attraction on the positive charge, the resultant force on the hydrogen molecule is non-zero and directed toward a direction of the injection-withdrawal well, thereby enabling the hydrogen to generate an acceleration toward the injection-withdrawal well and increasing the flow velocity of the hydrogen.

In the reservoir half-region controlled by the second electrode column module, the electric field density at the position where the positive charge of the hydrogen molecule is located is greater, and the electric field density at the position where the negative charge is located is lower, such that the electrostatic repulsion on the positive charge of the hydrogen molecule is greater than the electrostatic attraction on the negative charge, the resultant force on the hydrogen molecule is non-zero and directed toward the direction of the injection-withdrawal well, thereby enabling the hydrogen to generate an acceleration toward the injection-withdrawal well and increasing the flow velocity of the hydrogen.

Within a short time after the positive and negative poles of the non-uniform electric field are reversed, the hydrogen in the reservoir half-region controlled by the first electrode column module is accelerated to flow toward the injection-withdrawal well, and the hydrogen in the reservoir half-region controlled by the second electrode column module is also accelerated to flow toward the injection-withdrawal well, where the short time refers to a duration not exceeding 10⁻¹² seconds.

Further, when a long time has passed since reversal of the positive and negative poles of the non-uniform electric field, the hydrogen is polarized again according to a current electric field distribution to generate a positive charge along the direction of the electric field line and generate a negative charge along an opposite direction of the electric field line. In this case, a force-bearing state of the hydrogen is similar to that of the hydrogen during hydrogen injection, and the hydrogen tends to flow towards the first electrode column module and the second electrode column module. The long time refers to a duration exceeding 10⁻¹² seconds. During hydrogen withdrawal, to prevent the hydrogen from flowing toward the first electrode column module and the second electrode column module, the positive and negative poles of the non-uniform electric field are reversed again to ensure that the hydrogen is always accelerated to flow toward the injection-withdrawal well.

Therefore, during hydrogen withdrawal, the positive and negative poles of the non-uniform electric field need to be reversed at a frequency of 10¹² Hz, thereby preventing the hydrogen from flowing toward the first electrode column module and the second electrode column module and keeping hydrogen flowing toward the injection-withdrawal well at an accelerated rate.

Compared with the prior art, the present disclosure has beneficial effects as follows.

According to the present disclosure, a first electrode column module and a second electrode column module with charges of equal magnitude but opposite sign are symmetrically arranged on both sides of an injection-withdrawal well, and an additional electric field is applied to polarize a hydrogen molecule to generate an induced dipole. Afterwards, under the action of the electric field, the flow velocity of the hydrogen is improved, the hydrogen storage capacity is increased, and the hydrogen injection-withdrawal efficiency is improved.

### BRIEF DESCRIPTION OF THE DRAWINGS

FIG. 1 is a distribution diagram of an equipotential line of a non-uniform electric field.

FIG. 2 is a diagram of a force acting on a hydrogen molecule in the non-uniform electric field during hydrogen injection.

FIG. 3 is a diagram of a force acting on the hydrogen molecule within a short time after reversing a direction of the non-uniform electric field during hydrogen withdrawal.

FIG. 4 is a diagram of a force acting on the hydrogen molecule when a long time has passed since reversal of a direction of the non-uniform electric field during hydrogen withdrawal.

### DETAILED DESCRIPTION OF THE EMBODIMENTS

### Embodiment 1

An electric field-enhanced underground hydrogen storage system includes an injection-withdrawal well, a first electrode column module, and a second electrode column module.

The injection-withdrawal well is used for injection and withdrawal of hydrogen, which extends from a surface well-site into the interior of a reservoir and is located at a central position in the electric field-enhanced underground hydrogen storage system as a whole.

The first electrode column module represents an electrode of an electric field, such as a positive electrode or negative electrode. The first electrode column module is located at a side of the injection-withdrawal well and has a height equal to a reservoir thickness of an underground hydrogen storage structure. The second electrode column module represents another opposite electrode of the electric field, such as a negative electrode or a positive electrode. The second electrode column module is located at the other side of the injection-withdrawal well opposite to the first electrode column module, and has a height equal to the reservoir thickness of the underground hydrogen storage structure.

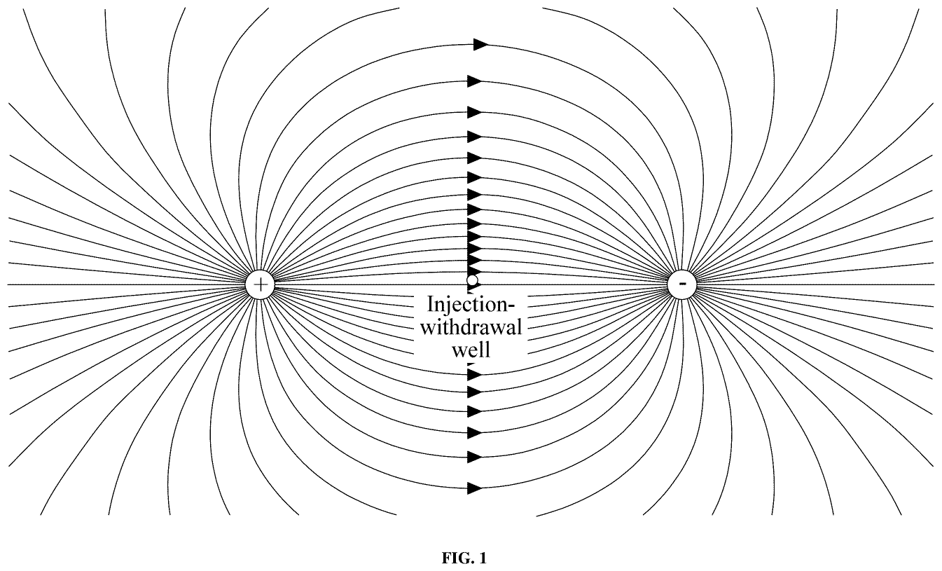

The first electrode column module and the second electrode column module carry charges of equal magnitude but opposite sign, and are located at both sides at a same distance from the injection-withdrawal well, thereby forming a non-uniform electric field in the reservoir. In this embodiment, each of the first electrode column module and the second electrode column module is about 300 m away from the injection-withdrawal well. As shown in FIG. 1, in a region closer to the first electrode column module and the second electrode column module, the electric field lines are denser, the electric potential is higher, and an electric field force exerted on the charge is greater.

In this embodiment, each of the first electrode column module and the second electrode column module includes an electrode column made of steel, and power supply equipment. The power supply equipment is configured to supply power to the electrode column to make the electrode column have a positive electrode and a negative electrode. When the power supply equipment is an alternating-current power supply, the positive and negative electrodes of the electrode column are alternatively reversed.

### Embodiment 2

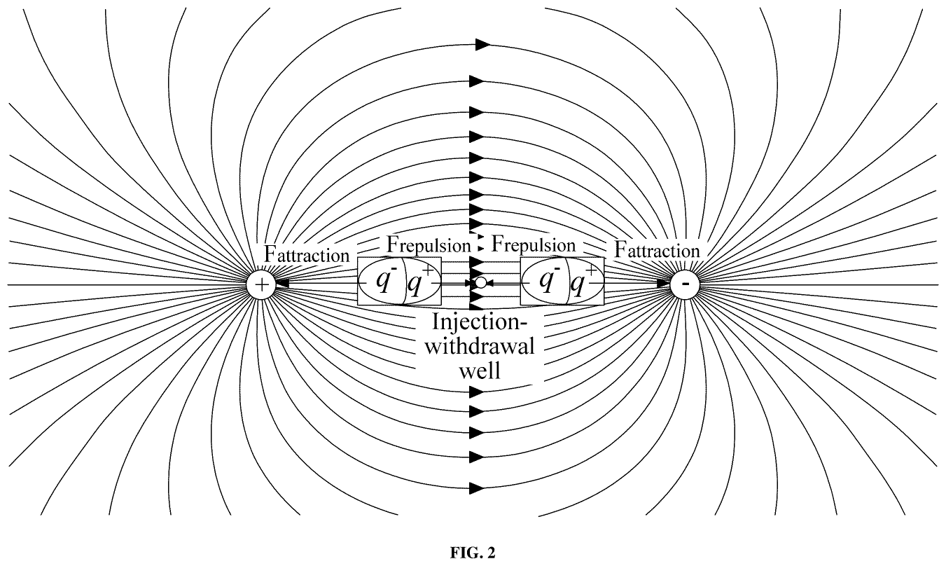

An electric field-enhanced underground hydrogen storage method is carried out using the electric field-enhanced underground hydrogen storage system in Embodiment 1. In the underground hydrogen storage engineering, the hydrogen is injected into a reservoir of an underground hydrogen storage structure through an injection-withdrawal well.
(1) During hydrogen injection, the hydrogen respectively enters a reservoir half-region controlled by a first electrode column module and a reservoir half-region controlled by a second electrode column module through the injection-withdrawal well. In this case, the first electrode column module is positively charged and the second electrode column module is negatively charged. The hydrogen is polarized in a non-uniform electric field formed by the first electrode column module and the second electrode column module, an induced dipole is generated as the centers of positive and negative charges of the hydrogen no longer coincide. The induced charges of equal magnitude but opposite sign are formed in a hydrogen molecule, where a positive charge is generated along a direction of an electric field line, and a negative charge is generated along an opposite direction of the electric field line, as shown in FIG. 2.

In the reservoir half-region controlled by the first electrode column module, an electric field density at a position where the negative charge of the hydrogen molecule is located is greater, and an electric field density at a position where the positive charge is located is lower. Thus, electrostatic attraction on the negative charge of the hydrogen molecule is greater than electrostatic repulsion on the positive charge, and a resultant force on the hydrogen molecule is non-zero and directed toward the first electrode column module. The hydrogen thus generates an acceleration toward the first electrode column module, and the flow velocity of the hydrogen is increased.

In the reservoir half-region controlled by the second electrode column module, an electric field density at a position where the positive charge of the hydrogen molecule is located is greater, and an electric field density at a position where the negative charge is located is lower. Thus, the electrostatic attraction on the positive charge of the hydrogen molecule is greater than the electrostatic repulsion on the negative charge, and a resultant force on the hydrogen molecule is non-zero and directed toward the second electrode column module. The hydrogen thus generates an acceleration toward the second electrode column module, and the flow velocity of the hydrogen is increased.

Therefore, during hydrogen injection, the hydrogen in the reservoir half-region controlled by the first electrode column module is accelerated to flow toward the first electrode column module, and the hydrogen in the reservoir half-region controlled by the second electrode column module is accelerated to flow toward the second electrode column module. The resultant force on the hydrogen molecule not only makes the hydrogen have an acceleration toward the electrode column to improve the flow velocity of the hydrogen, but also plays a role in compressing the hydrogen in the reservoir to increase the hydrogen storage capacity of the reservoir.
(2) During hydrogen withdrawal, the hydrogen enters the injection-withdrawal well from the reservoir half-region controlled by the first electrode column module and the reservoir half-region controlled by the second electrode column module and is recovered to a surface well-site.

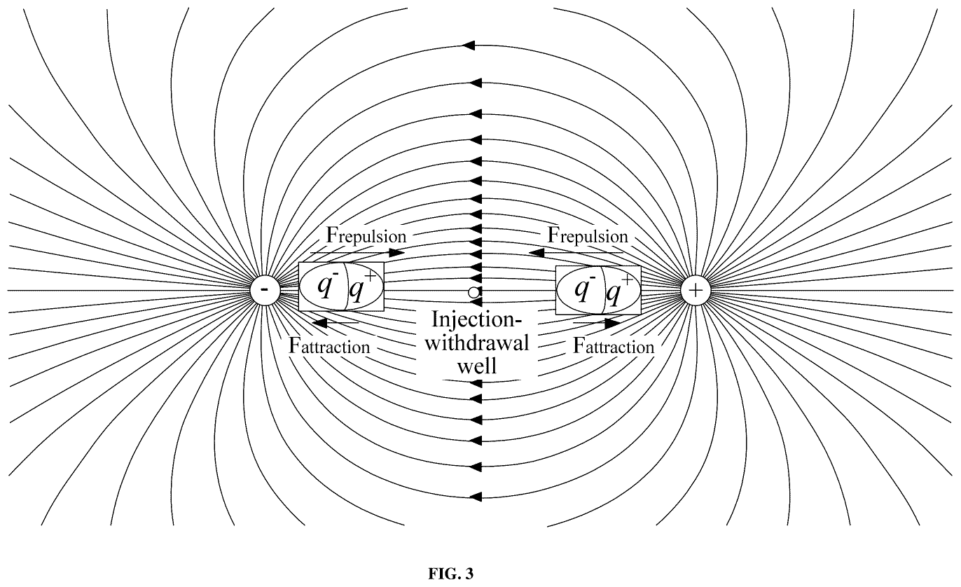

Positive and negative poles of the non-uniform electric field are reversed, such that the first electrode column module is negatively charged and the second electrode column module is positively charged, as shown in FIG. 3. In this case, the hydrogen is still in a polarized state established before electric field reversal.

In the reservoir half-region controlled by the first electrode column module, the electric field density at the position where the negative charge of the hydrogen molecule is located is greater, and the electric field density at the position where the positive charge is located is lower. Thus, the electrostatic repulsion on the negative charge of the hydrogen molecule is greater than the electrostatic attraction on the positive charge, and the resultant force on the hydrogen molecule is non-zero and directed toward a direction of the injection-withdrawal well. The hydrogen thus generates an acceleration toward the injection-withdrawal well, and the flow velocity of the hydrogen is increased.

In the reservoir half-region controlled by the second electrode column module, the electric field density at the position where the positive charge of the hydrogen molecule is located is greater, and the electric field density at the position where the negative charge is located is lower. Thus, the electrostatic repulsion on the positive charge of the hydrogen molecule is greater than the electrostatic attraction on the negative charge, and the resultant force on the hydrogen molecule is non-zero and directed toward a direction of the injection-withdrawal well. The hydrogen thus generates an acceleration toward the injection-withdrawal well, and the flow velocity of the hydrogen is increased.

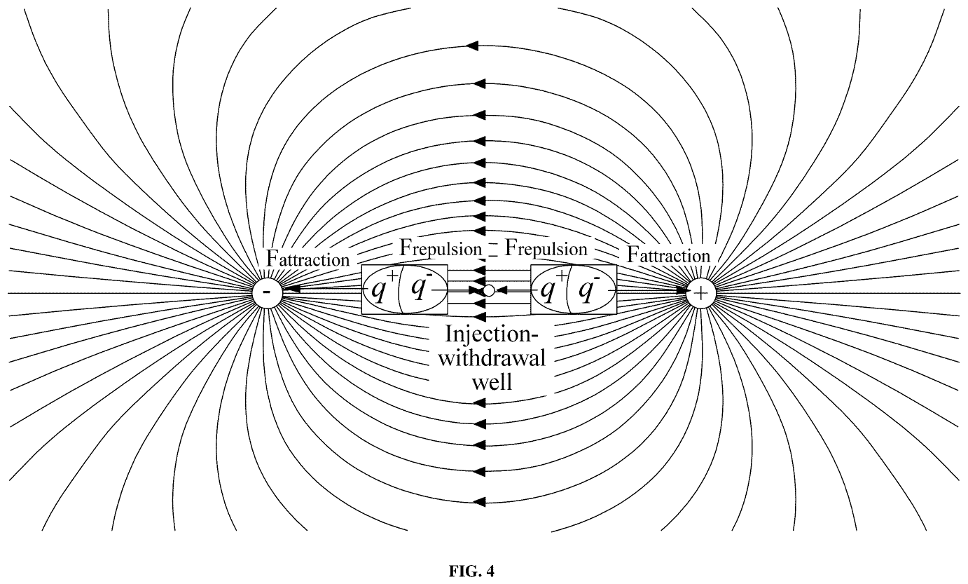

Within a short time (10⁻¹² seconds) after the positive and negative poles of the non-uniform electric field are reversed, the hydrogen in the reservoir half-region controlled by the first electrode column module is accelerated to flow toward the injection-withdrawal well, and the hydrogen in the reservoir half-region controlled by the second electrode column module also is accelerated to flow toward the injection-withdrawal well. Under the action of the non-uniform electric field, the resultant force on the hydrogen makes the hydrogen generate an acceleration toward the injection-withdrawal well, which can drive the hydrogen to enter the injection-withdrawal well, improving the flow velocity and withdrawal efficiency of the hydrogen.
(3) When a long time (greater than 10⁻¹² seconds) has passed since reversal of the positive and negative poles of the non-uniform electric field, the hydrogen is polarized again according to a current electric field distribution to generate a positive charge along a direction of an electric field line and generate a negative charge along an opposite direction of the electric field line, as shown in FIG. 4. In this case, a force-bearing state of the hydrogen is similar to that of the hydrogen during hydrogen injection, and the hydrogen tends to flow towards the first electrode column module and the second electrode column module. During hydrogen withdrawal, to prevent the hydrogen from flowing toward the first electrode column module and the second electrode column module, the positive and negative poles of the non-uniform electric field need to be reversed again to ensure that the hydrogen is always accelerated to flow toward the injection-withdrawal well.

Therefore, during hydrogen withdrawal, the positive and negative poles of the non-uniform electric field need to be reversed at a frequency of 10¹² Hz, thereby preventing the hydrogen from flowing toward the first electrode column module and the second electrode column module and keeping hydrogen flowing toward the injection-withdrawal well at an accelerated rate. The reversing the positive and negative poles of the non-uniform electric field refers to reversing charge polarity of the electrode column from positive to negative or from negative to positive.

The present disclosure achieves electric field-enhanced underground hydrogen storage, which is applied in underground hydrogen storage projects and is conducive to improving the injection-withdrawal efficiency and increasing the hydrogen storage capacity.

Certainly, the foregoing description is not intended to limit the present disclosure, nor is the present disclosure merely limited to the foregoing examples. Changes, modifications, additions, or substitutions made by those skilled in the art within the essence and scope of the present disclosure shall also fall within the scope of protection of the present disclosure.

What is claimed is:

1. An electric field-enhanced underground hydrogen storage system, comprising an injection-withdrawal well, a first electrode column module, and a second electrode column module; wherein
the injection-withdrawal well is used for injection and withdrawal of hydrogen, the first electrode column module represents an electrode of an electric field, and the second electrode column module represents another opposite electrode of the electric field;
the first electrode column module and the second electrode column module respectively carry charges of equal magnitude but opposite sign, and are located at both sides at a same distance from the injection-withdrawal well, thereby forming a non-uniform electric field in a reservoir;
the injection-withdrawal well extends from a surface well-site into an interior of the reservoir and is located at a central position in the electric field-enhanced underground hydrogen storage system as a whole;
the first electrode column module is located at a side of the injection-withdrawal well, and has a height equal to a reservoir thickness of an underground hydrogen storage structure; and
the second electrode column module is located at another side of the injection-withdrawal well opposite to the first electrode column module, and has a height equal to the reservoir thickness of the underground hydrogen storage structure.

2. An electric field-enhanced underground hydrogen storage method, carried out using the electric field-enhanced underground hydrogen storage system according to claim 1, comprising:
injecting the hydrogen into the reservoir of the underground hydrogen storage structure through the injection-withdrawal well, wherein during injection, the hydrogen is polarized in the non-uniform electric field formed by the first electrode column module and the second electrode column module, and an induced dipole is generated as centers of positive and negative charges of the hydrogen no longer coincide; induced charges of equal magnitude but opposite sign are formed in a hydrogen molecule; and two types of induced charges are subjected to electrostatic attraction and electrostatic repulsion of different magnitudes and opposite directions from the non-uniform electric field, thereby enabling the hydrogen to have a directional acceleration moving toward either the first electrode column module or the second electrode column module; and
withdrawing the hydrogen to a surface through the injection-withdrawal well, wherein during withdrawal, positive and negative poles of the non-uniform electric field are reversed according to a predetermined frequency, enabling the hydrogen to have a directional acceleration moving toward the injection-withdrawal well;
wherein reversing the positive and negative poles of the non-uniform electric field refers to reversing charge polarities of the first electrode column module and the second electrode column module.

3. The electric field-enhanced underground hydrogen storage method according to claim 2, wherein during hydrogen injection, the hydrogen respectively enters a reservoir half-region controlled by the first electrode column module and a reservoir half-region controlled by the second electrode column module through the injection-withdrawal well, in which the first electrode column module is positively charged and the second electrode column module is negatively charged;
the hydrogen is polarized in the non-uniform electric field formed by the first electrode column module and the second electrode column module, and the induced dipole is generated as the centers of the positive and negative charges of the hydrogen no longer coincide; the induced charges of equal magnitude but opposite sign are formed in the hydrogen molecule, wherein a positive charge is generated along a direction of an electric field line, and a negative charge is generated along an opposite direction of the electric field line;
in the reservoir half-region controlled by the first electrode column module, an electric field density at a position where the negative charge of the hydrogen molecule is located is greater, and an electric field density at a position where the positive charge is located is lower, such that electrostatic attraction on the negative charge of the hydrogen molecule is greater than electrostatic repulsion on the positive charge, a resultant force on the hydrogen molecule is non-zero and directed toward the first electrode column module, thereby enabling the hydrogen to generate an acceleration toward the first electrode column module and increasing a flow velocity of the hydrogen;
in the reservoir half-region controlled by the second electrode column module, an electric field density at a position where the positive charge of the hydrogen molecule is located is greater, and an electric field density at a position where the negative charge is located is lower, such that electrostatic attraction on the positive charge of the hydrogen molecule is greater than electrostatic repulsion on the negative charge, a resultant force on the hydrogen molecule is non-zero and directed toward the second electrode column module, thereby enabling the hydrogen to generate an acceleration toward the second electrode column module and increasing a flow velocity of the hydrogen; and
during the hydrogen injection, the hydrogen in the reservoir half-region controlled by the first electrode column module is accelerated to flow toward the first electrode column module, and the hydrogen in the reservoir half-region controlled by the second electrode column module is accelerated to flow toward the second electrode column module.

4. The electric field-enhanced underground hydrogen storage method according to claim 3, wherein during hydrogen withdrawal, the hydrogen enters the injection-withdrawal well from the reservoir half-region controlled by the first electrode column module and the reservoir half-region controlled by the second electrode column module and is recovered to the surface well-site;
the positive and negative poles of the non-uniform electric field are reversed, such that the first electrode column module is negatively charged and the second electrode column module is positively charged, upon which the hydrogen is still in a polarized state before electric field reversal;
in the reservoir half-region controlled by the first electrode column module, the electric field density at the position where the negative charge of the hydrogen molecule is located is greater, and the electric field density at the position where the positive charge is located is lower, such that electrostatic repulsion on the negative charge of the hydrogen molecule is greater than electrostatic attraction on the positive charge, the resultant force on the hydrogen molecule is non-zero and directed toward a direction of the injection-withdrawal well, thereby enabling the hydrogen to generate an acceleration toward the injection-withdrawal well and increasing the flow velocity of the hydrogen;
in the reservoir half-region controlled by the second electrode column module, the electric field density at the position where the positive charge of the hydrogen molecule is located is greater, and the electric field density at the position where the negative charge is located is lower, such that electrostatic repulsion on the positive charge of the hydrogen molecule is greater than electrostatic attraction on the negative charge, the resultant force on the hydrogen molecule is non-zero and directed toward a direction of the injection-withdrawal well, thereby enabling the hydrogen to generate an acceleration toward the injection-withdrawal well and increasing the flow velocity of the hydrogen;
within a short time after the positive and negative poles of the non-uniform electric field are reversed, the hydrogen in the reservoir half-region controlled by the first electrode column module is accelerated to flow toward the injection-withdrawal well, and the hydrogen in the reservoir half-region controlled by the second electrode column module is accelerated to flow toward the injection-withdrawal well, wherein the short time refers to a duration not exceeding 10⁻¹² seconds;
when a long time has passed since reversal of the positive and negative poles of the non-uniform electric field, the hydrogen is polarized again according to a current electric field distribution to generate a positive charge along the direction of the electric field line and generate a negative charge along the opposite direction of the electric field line, wherein the long time refers to a duration exceeding 10⁻¹² seconds; and
during the hydrogen withdrawal, to prevent the hydrogen from flowing toward the first electrode column module and the second electrode column module, the positive and negative poles of the non-uniform electric field are reversed again to ensure that the hydrogen is always accelerated to flow toward the injection-withdrawal well.
